(19) United States
(12) Patent Application Publication
(10) Pub. No.: US 2025/0051581 A1
(43) Pub. Date: Feb. 13, 2025

(54) POLYMER EMULSION, STORAGE METHOD THEREFOR, TWO-PACK TYPE HEAT-CURABLE RESIN COMPOSITION USING SAID POLYMER EMULSION, CURED RESIN FILM, AND COATING FILM

(71) Applicant: Resonac Corporation, Tokyo (JP)

(72) Inventors: Yuki WATANABE, Minato-ku, Tokyo (JP); Naoki SEKIOKA, Minato-ku, Tokyo (JP)

(73) Assignee: Resonac Corporation, Tokyo (JP)

(21) Appl. No.: 18/722,069

(22) PCT Filed: Dec. 15, 2022
(86) PCT No.: PCT/JP2022/046196

§ 371 Date: Jun. 20, 2024

(30) Foreign Application Priority Data
Dec. 21, 2021 (JP) 2021-207369

(51) Int. Cl. C09D 5/02; C08F 220/18; C08L 33/12; C09D 133/12

(52) U.S. Cl. CPC C09D 5/022; C08F 220/18; C08L 33/12; C09D 133/12; C08L 2201/52

(57) ABSTRACT

The purpose of the present invention is to provide a polymer emulsion having excellent preservation stability, a thermosetting resin composition containing the polymer emulsion, and having excellent curability at low temperature, a coating material containing the thermosetting resin composition, a resin cured film obtained by curing the thermosetting resin composition, a coating film including the resin cured film, and a method for storing the polymer emulsion. The present invention includes an invention of a polymer emulsion (B) including a polymer (A) containing a constituent unit (A-1), and water, wherein a content ratio of the constituent unit (A-1) when a total content of all constituent units of the polymer (A) is defined as 100 mol % is 0.5 mol % or more and 40 mol % or less.

### TECHNICAL FIELD

The present invention relates to a polymer emulsion, a method for storing the polymer emulsion, a two-component thermosetting resin composition containing the polymer emulsion, a resin cured film, and a coating film.

### BACKGROUND ART

A blocked isocyanate compound is a compound obtained by reacting an isocyanato group of a compound having an isocyanato group with a blocking agent to inactivate (block) the reactivity of the isocyanato group. A blocked isocyanate compound, in which an isocyanato group is blocked, thus is not necessarily prepared and preserved separately from a compound having a functional group reactive with an isocyanato group, such as an active hydrogen group, and can also be prepared and preserved together with such a compound as one component. For this reason, blocked isocyanate compounds are widely used for, for example, adhesives, coating agents, molding materials, and resin compositions.

In recent years, aqueous resin compositions have attracted attention due to, for example, the increased awareness of global environment protection.

For example, Patent Literature 1 discloses, for example, a one-component crosslinked polymer emulsion composition obtained by emulsion polymerization of a monomer composition composed of an ethylenically unsaturated monomer having a 4,5-dihydroxy-2-imidazolidinone group, which is obtained by reacting glyoxal under the condition of a pH of 6 to 8 with an ethylenically unsaturated monomer having a urea group, which is obtained by a reaction of an ethylenically unsaturated monomer having an isocyanate group and amine, and another ethylenically unsaturated monomer.

Patent Literature 2 discloses an aqueous resin composition which contains a polymer obtained by polymerizing a vinyl monomer (A) containing an isocyanate group blocked as a sulfurous acid or hydrogen sulfite adduct, and an ethylenically unsaturated compound (B) containing an active hydrogen group reactive with an isocyanate group, or a polymer obtained by polymerizing the vinyl monomer (A), the ethylenically unsaturated compound (B) and another ethylenically unsaturated compound (C) and in which the vinyl monomer (A) contains a predetermined compound.

Patent Literature 3 discloses a water dispersion-type blocked isocyanate composition containing a blocked isocyanate in which an isocyanate group is blocked with a blocking agent, and a dispersant which is free of a protective colloid agent and contains a predetermined surfactant.

Patent Literature 4 discloses a copolymer (A) containing a constituent unit (a) having a blocked isocyanato group, a constituent unit (b) having an acid group, and a constituent unit (c) having an epoxy group.

Patent Literature 5 discloses a photosensitive resin composition which contains a copolymer (A) containing a constituent unit (a) having a blocked isocyanato group and a constituent unit (b) having an acid group, a hydroxyl group-containing organic solvent (B), a reactive diluent (C), and a photopolymerization initiator (D).

### CITATION LIST

### Patent Literature

Patent Literature 1: JP2010-59239A
Patent literature 2: JP3517821
Patent literature 3: JP5563864
Patent Literature 4: WO2019/026546
Patent Literature 5: WO2019/026547

### SUMMARY OF INVENTION

### Technical Problem

In Patent Literature 1, a polymer emulsion is dried at 110° C. for 10 minutes to prepare a resin, but the preservation stability of the polymer emulsion is not examined.

In Patent Literature 2, even when a dispersion of an aqueous resin composition is left to stand at room temperature for 3 months, precipitation does not occur, and thus excellent stability is exhibited, but the temperature at which the aqueous resin composition is cured by heating is 130° C. to 200° C.

In Patent Literature 3, it is indicated that even when a water dispersion-type blocked isocyanate composition is left to stand at 25° C. for 1 week, phase separation is observed by eye, but the temperature at which the composition is cured by heating is 130° C. to 160° C.

In Patent Literature 4, it is possible to perform thermal curing at 100° C., but since a compound having an epoxy group reacts with water, it is necessary that a film be sufficiently dried after being formed, and since a composition containing an organic solvent is prepared, there is room for improvement from the perspective of reducing the amount of a volatile organic compound (VOC).

In Patent Literature 5, it is possible to perform thermal curing at 100° C., but since a reaction of a blocking group in a compound having a blocked isocyanato group and a hydroxyl group in a compound having a hydroxyl group becomes slower as the average molecular weight of a copolymer increases, it is necessary the amount of an expensive blocked isocyanate monomer used to be increased for improving the reaction. Thus, there is room for improvement.

The present invention has been made for solving the problems described above, and an object of the present invention is to provide a polymer emulsion having excellent preservation stability, a thermosetting resin composition containing the polymer emulsion, and having excellent curability at low temperature, a coating material containing the thermosetting resin composition, a resin cured film obtained by curing the thermosetting resin composition, a coating film including the resin cured film, and a method for storing the polymer emulsion.

### Solution to Problem

The present invention includes the following aspects.

[1]A polymer emulsion (B) comprising a polymer (A) containing a constituent unit (A-1) represented by the following formula (1), and water, wherein a content ratio of the constituent unit (A-1) when a total content of all constituent units of the polymer (A) is defined as 100 mol % is 0.5 mol % or more and 40 mol % or less:

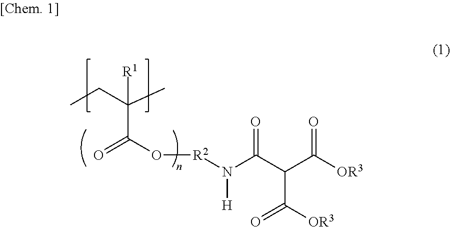

wherein R¹ represents a hydrogen atom or a methyl group, R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond, R³ and R⁴ each independently represent a hydrogen atom, an alkyl group having 1 to 10 carbon atoms, or a cycloalkyl group or arylalkyl group having 6 to 20 carbon atoms, and n is 1 or 2.

[2] The polymer emulsion (B) according to [1], wherein the constituent unit (A-1) is represented by formula (1-1):

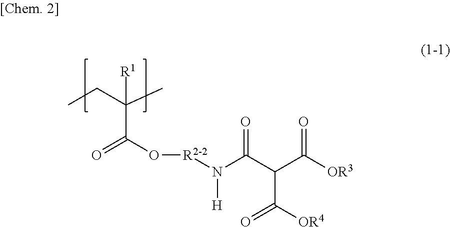

wherein R¹, R³ and R⁴ have the same meanings as the symbols in formula (1), and R²⁻² represents a divalent aliphatic saturated hydrocarbon group having 2 to 4 carbon atoms and optionally having an ether bond.

[3] The polymer emulsion (B) according to [1] or [2], wherein the constituent unit (A-1) is represented by formula (1-2):

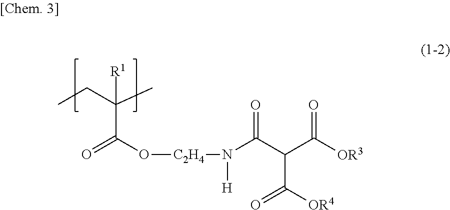

wherein R¹, R³ and R⁴ have the same meanings as the symbols in formula (1).

[4] The polymer emulsion (B) according to any one of [1] to [3], wherein each of R³ and R⁴ in the formula of the constituent unit (A-1) is an ethyl group.

[5] The polymer emulsion (B) according to any one of [1] to [4], wherein the polymer (A) contains a constituent unit (A-3) represented by the following formula (3) as a constituent unit of the polymer (A):

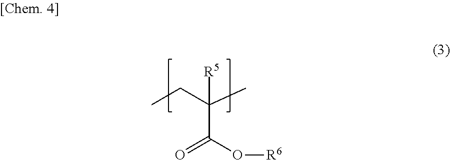

wherein R⁵ represents a hydrogen atom, or an aliphatic saturated hydrocarbon group having 1 to 4 carbon atoms and containing a straight chain or a branched chain; and R⁶ represents an aliphatic saturated hydrocarbon group having 1 to 18 carbon atoms or an aromatic hydrocarbon group having 6 to 19 carbon atoms, which optionally contains an ether bond and/or a sulfide bond and in which a hydrogen atom is optionally replaced by a hydroxyl group, a nitro group, a carboxy group, a salt of a carboxy group, a sulfo group, a salt of a sulfo group, an amino group, a nitroso group, a cyano group, a sulfino group, a chlorine atom, a fluorine atom, a bromine atom, an iodine atom, or an astatine atom.

[6] The polymer emulsion (B) according to any one of [1] to [5], wherein the polymer (A) further contains a constituent unit (A-2) represented by the following formula (2) as a constituent unit of the polymer:

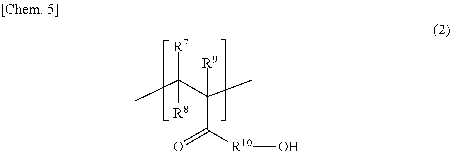

wherein R⁷, R⁸ and R⁹ each independently represent a hydrogen atom, or a hydrocarbon group containing a straight chain or a branched chain having 1 to 6 carbon atoms and optionally containing an ester bond and/or a carboxy group, and R¹⁰ represents a hydrocarbon group containing a straight chain or a branched chain having 0 to 18 carbon atoms and optionally having at least one selected from an ester bond, a carbonyl group and an ether bond.

[7] The polymer emulsion (B) according to any one of [1] to [6], wherein a glass transition temperature (Tg) of a solid content in the polymer emulsion (B) is 0° C. or higher and 110° C. or lower.

[8]A two-component thermosetting resin composition (G) comprising the polymer emulsion (B) according to any one of [5] to [7], and an acrylic polyol polymer emulsion (F).

[9] The two-component thermosetting resin composition (G) according to [8], wherein a ratio between the number of moles of the constituent unit (A-1) in the polymer emulsion (B) and the number of moles of hydroxyl groups in the acrylic polyol polymer emulsion (F) is 2:1 to 1:4.

[10]A resin cured film (H) obtained by curing the two-component thermosetting resin composition (G) according to [8] or [9].

[11]A coating film (I) comprising the resin cured film (H) according to [10].

[12]A method for storing a polymer emulsion (B), comprising storing the polymer emulsion (B) according to any one of [1] to [7] at a temperature of 0° C. to 25° C.

### Advantageous Effects of Invention

According to the present invention, it is possible to provide a polymer emulsion having excellent preservation stability, a thermosetting resin composition containing the polymer emulsion, and having excellent curability at low temperature, a coating material containing the thermosetting resin composition, a resin cured film obtained by curing the thermosetting resin composition, a coating film including the resin cured film, and a method for storing the polymer emulsion.

### DESCRIPTION OF EMBODIMENTS

Hereinafter, embodiments of the present invention will be described in detail. However, it should be understood that the present invention is not limited to the embodiments shown below.

As used herein, the term “(meth)acrylate” means that it may be either acrylate or methacrylate. The term “(meth)acrylic acid” means that it may be either acrylic acid or methacrylic acid.

### <Polymer Emulsion (B)>

An embodiment of the present invention is a polymer emulsion (B) comprising a polymer (A) containing a constituent unit (A-1) represented by the following formula (1), and water, wherein a content ratio of the constituent unit (A-1) when a total content of all constituent units of the polymer (A) is defined as 100 mol % is 0.5 mol % or more and 40 mol % or less.

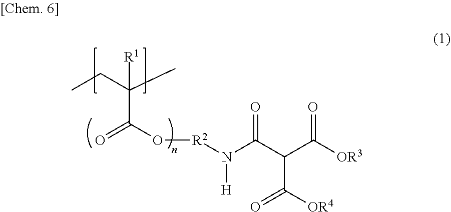

In formula (1), R¹ represents a hydrogen atom or a methyl group, R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond, R³ and R⁴ each independently represent a hydrogen atom, an alkyl group having 1 to 10 carbon atoms, or a cycloalkyl group or arylalkyl group having 6 to 20 carbon atoms, and n is 1 or 2.

### [Polymer (A)]

The polymer (A) according to the present invention contains a constituent unit (A-1) represented by formula (1) (hereinafter, also refers to a “constituent unit (A-1)”), where the content of the constituent unit (A-1) represented by the following formula (1) is 0.5 mol % or more and 40 mol % or less when the total content of all of constituent units (A-1) to (A-3) (hereinafter, referred to as “all constituent units”) is defined as 100 mol %. Preferably, the polymer (A) further contains a constituent unit (A-2) represented by formula (2) (hereinafter, also referred to as a “constituent unit (A-2)) and/or a constituent unit (A-3) represented by formula (3) (hereinafter, also referred to as a “constituent unit (A-3)).

### [Constituent Unit (A-1)]

The constituent unit (A-1) of the polymer (A) is represented by formula (1). The constituent unit (A-1) may be of one type or a combination of two or more types.

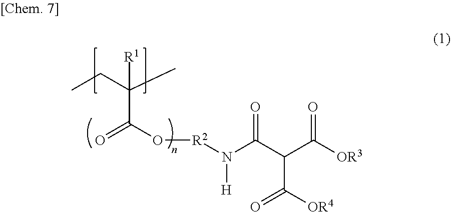

In formula (1), R¹ represents a hydrogen atom or a methyl group, and R² represents a di- to tetravalent, and preferably divalent aliphatic saturated hydrocarbon group having 1 to 20 carbon atoms, preferably having 1 to 8 carbon atoms, and containing a straight chain or a branched chain optionally having an ether bond, or a divalent alicyclic hydrocarbon group or aromatic hydrocarbon group having 6 to 20 carbon atoms and optionally having a urethane bond. R³ and R⁴ each independently represent a hydrogen atom, an alkyl group having 1 to 10 carbon atoms, preferably having 2 to 8 carbon atoms, or a cycloalkyl group or arylalkyl group having 6 to 20 carbon atoms, preferably having 6 to 12 carbon atoms, and are each more preferably a methyl group or an ethyl group, and particularly preferably an ethyl group. n is 1 or 2.

The constituent unit (A-1) is preferably represented by formula (1-1), and more preferably represented by formula (1-2).

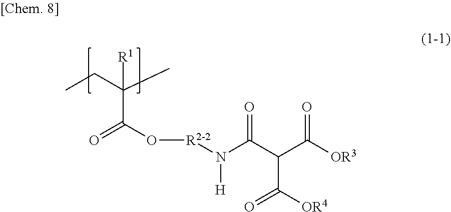

In formula (1-1), R¹, R³ and R⁴ have the same meanings as the symbols in formula (1), and R²⁻² represents a divalent aliphatic saturated hydrocarbon group having 2 to 4 carbon atoms and optionally having an ether bond.

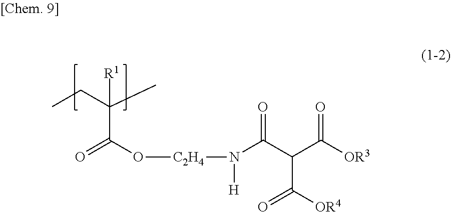

In formula (1-2), R¹, R³ and R⁴ have the same meanings as the symbols in formula (1).

In another form of the present invention, the constituent unit (A-1) is preferably represented by formula (1-3).

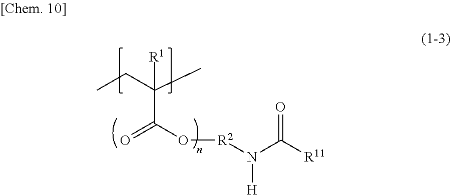

In formula (1-3), R¹ and R² have the same meanings as the symbols in formula (1). R² is more preferably a divalent aliphatic saturated hydrocarbon group having 2 to 4 carbon atoms and optionally having an ether bond, and further preferably an ethylene group, and n is preferably 1. R¹¹ represents a blocking agent of an isocyanato group (R¹¹—H) described later, or a residue of a salt thereof.

The constituent unit (A-1) is preferably a constituent unit derived from a monomer obtained by blocking an isocyanate monomer (a-1-1) with a blocking agent (a-1-2) (hereinafter, also referred to as a “blocked isocyanate monomer (a-1)”.

The isocyanate monomer (a-1-1) is preferably represented by the following formula (4).

(CH₂═CR¹—C(═O)O)ₙ—R²—NCO (4)

In formula (4), R¹, R² and n have the same meanings as the symbols in formula (1).

Examples of the isocyanate monomer (a-1-1) represented by formula (4) include a (meth)acrylic acid ester compound having an isocyanato group, and an adduct of hydroxyl group-containing (meth)acrylate and a diisocyanate compound at 1:1 (molar ratio).

Examples of the (meth)acrylic acid ester compound having an isocyanato group include 2-(meth)acryloyloxyethyl isocyanate, 3-(meth)acryloyloxy-n-propyl isocyanate, 2-(meth)acryloyloxyisopropyl isocyanate, 4-(meth)acryloyloxy-n-butyl isocyanate, 2-(meth)acryloyloxy-tert-butyl isocyanate, 2-(meth)acryloyloxybutyl-4-isocyanate, 2-(meth)acryloyloxybutyl-3-isocyanate, 2-(meth)acryloyloxybutyl-2-isocyanate, 2-(meth)acryloyloxybutyl-1-isocyanate, 5-(meth)acryloyloxy-n-pentyl isocyanate, 6-(meth)acryloyloxy-n-hexyl isocyanate, 7-(meth)acryloyloxy-n-heptyl isocyanate, 2-(isocyanatoethyloxy)ethyl (meth)acrylate, 3-(meth)acryloyloxyphenyl isocyanate, 4-(meth)acryloyloxyphenyl isocyanate, 1,1-bis((meth)acryloyloxyethyl)methyl isocyanate, and 1,1-bis((meth)acryloyloxymethyl)ethyl isocyanate.

Examples of the hydroxyl group-containing (meth)acrylate include 2-hydroxyalkyl (meth)acrylate. The alkyl group of 2-hydroxyalkyl (meth)acrylate is preferably an ethyl group or a n-propyl group, and more preferably an ethyl group.

Examples of the diisocyanate compound include hexamethylene diisocyanate, 2,4-(or 2,6-)tolylene diisocyanate (TDI), 4,4′-diphenylmethane diisocyanate (MDI), 3,5,5-trimethyl-3-isocyanatomethylcyclohexyl isocyanate (IPDI), m-(or p-)xylene diisocyanate, 1,3-(or 1,4-)bis(isocyanatomethyl)cyclohexane, and lysine diisocyanate.

In particular, from the viewpoint of ease of production and/or availability of raw materials, the isocyanate monomer (a-1-1) is preferably 2-(meth)acryloyloxyethyl isocyanate, 2-(isocyanatoethyloxy)ethyl (meth)acrylate, or 1,1-bis((meth)acryloyloxymethyl)ethyl isocyanate, and more preferably 2-(meth)acryloyloxyethyl isocyanate.

The blocking agent (a-1-2) is represented by R¹¹—H, and includes a salt thereof. R¹¹ is —C(COOR³) (COOR⁴)R¹², and R³ and R⁴ have the same meanings as the symbols in formula (1). R¹² is a hydrogen atom, or a hydrocarbon group having 1 to 10 carbon atoms, preferably having 1 to 6 carbon atoms, and optionally having a substituent.

The blocking agent (a-1-2) is preferably a malonic acid dialkyl ester, more preferably at least one selected from a malonic acid diester, a malonic acid monoester and malonic acid, and further preferably a malonic acid diester.

The malonic acid monoester and the malonic acid diester can be obtained by, for example, reacting an aliphatic alcohol such as methanol, ethanol, isopropanol, n-propanol, n-butanol, isobutyl alcohol, sec-butyl alcohol, tert-butyl alcohol or 2-ethylhexyl alcohol; an alicyclic alcohol such as cyclohexyl methanol; or an alcohol containing an aromatic ring, such as benzyl alcohol and malonic acid, and may a mixture of two esters from different alcohols. Of these, a dimethyl ester or a diethyl ester is preferable, and a diethyl ester is more preferable, from the viewpoint of ease of volatilization of alcohol, availability, cost and quality.

When the blocking agent (a-1-2) is a malonic acid dialkyl ester, an ester exchange reaction very easily proceeds, and presence of a hydroxyl group facilitates the exchange. It is predicted that the reaction is an equilibrium reaction, and alcohol generated by ester exchange of the original alkyl ester of the blocking agent volatilizes and escapes to outside the system, so that the equilibrium reaction shifts from equilibrium toward formation of esters with other hydroxyl groups, resulting in progress of crosslinking.

Examples of the salt of R¹¹—H include salts of metals of group 1, group 2 and group 13 of the periodic table. In particular, the salt of R¹¹—H is preferably a salt of sodium, potassium, magnesium, calcium or aluminum, and more preferably a salt of sodium or aluminum.

The blocked isocyanate monomer (a-1) can be produced by a known method. The production can be performed by, for example, reacting an isocyanate monomer (a-1-1) and a blocking agent (a-1-2) in a reaction container by one of the following methods (i) to (iii).

(i) A reaction vessel is charged with the blocking agent (a-1-2), and the isocyanate monomer (a-1-1) is added with stirring to react the mixture

(ii) A reaction vessel is charged with the isocyanate monomer (a-1-1), and the blocking agent (a-1-2) is added with stirring to react the mixture

(iii) Both the blocking agent (a-1-2) and the isocyanate monomer (a-1-1) are simultaneously added into a reaction vessel with stirring to react the mixture

The reaction temperature is not particularly limited, and can be appropriately set according to the types of the isocyanate monomer (a-1-1) and the blocking agent (a-1-2) and the amount ratio thereof, but is, for example, preferably −10° C. or higher and 90° C. or lower, and more preferably 5° C. or higher and 70° C. or lower. The reaction time is not particularly limited, and can be appropriately set, but is preferably 30 minutes or more and 168 hours or less.

As the blocked isocyanate monomer (a-1), a commercially available product can also be used. Examples of the commercially available product include Karenz (registered trademark) MOI-DEM and Karenz (registered trademark) AOI-DEM manufactured by Showa Denko K.K.

The content ratio of the constituent unit (A-1) when the total content of all constituent units of the polymer (A) is defined as 100 mol % is preferably 0.5 mol % or more, more preferably 1.0 mol % or more, and further preferably 2.0 mol % or more, and preferably 40 mol % or less, more preferably 35.5 mol % or less, and further preferably 30.0 mol % or less.

### [Constituent Unit (A-2)]

A polymer (A) in an embodiment of the present invention may contain a constituent unit (A-2). The constituent unit (A-2) is represented by the following formula (2).

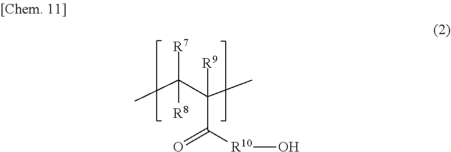

In formula (2), R⁷, R⁸ and R⁹ each independently represent a hydrogen atom, or a hydrocarbon group containing a straight chain or a branched chain having 1 to 6 carbon atoms, preferably having 1 to 4 carbon atoms, and optionally containing an ester bond and/or a carboxy group, and R¹⁰ represents a hydrocarbon group containing a straight chain or a branched chain having 0 to 18 carbon atoms, and more preferably having 0 to 12 carbon atoms, and optionally having at least one selected from an ester bond, a carbonyl group and an ether bond.

The constituent unit (A-2) is preferably a constituent unit derived from the monomer (a-2). Examples of the monomer (a-2) include unsaturated monocarboxylic acids such as (meth)acrylic acid, crotonic acid, 2-pentenoic acid and cinnamic acid; unsaturated dicarboxylic acids such as fumaric acid, maleic acid and itaconic acid; butenedioic acid mono-chain alkyl esters such as monomethyl fumarate, monoethyl fumarate, mono-n-butyl fumarate, monomethyl maleate, monoethyl maleate, mono(2-ethylhexyl) maleate and mono-n-butyl maleate; butenedioic acid monocyclic alkyl esters such as monocyclopentyl fumarate, monocyclohexyl fumarate, monocyclopentyl maleate and monocyclohexyl maleate; itaconic acid monoesters such as monomethyl itaconate, monoethyl itaconate, mono-n-butyl itaconate and monocyclohexyl itaconate; and 2-hydroxyethyl (meth)acrylate, 2-hydroxypropyl (meth)acrylate, 3-hydroxypropyl (meth)acrylate, 3-hydroxyphenyl (meth)acrylate, 4-hydroxybutyl (meth)acrylate, 6-hydroxyhexyl (meth)acrylate and mono-2-((meth)acryloyloxy)ethylsuccinic acid. Of these, (meth)acrylic acid, unsaturated dicarboxylic acid monoesters such as monoethyl fumarate, monopropyl fumarate, monobutyl fumarate, monoethyl itaconate, monopropyl itaconate, and monobutyl itaconate, 2-hydroxyethyl (meth)acrylate, and 4-hydroxybutyl (meth)acrylate are preferable, and (meth)acrylic acid is more preferable.

The constituent unit (A-2) may be of one type or a combination of two or more types.

The content ratio of the constituent unit (A-2) when the total content of all constituent units of the polymer (A) is defined as 100 mol % is preferably 0.5 mol % or more, more preferably 1.0 mol % or more, and further preferably 1.5 mol % or more, and preferably 20.0 mol % or less, more preferably 15.0 mol % or less, and further preferably 10.0 mol % or less.

### [Constituent (A-3)]

A polymer (A) in an embodiment of the present invention may contain a constituent unit (A-3). The constituent unit (A-3) is a constituent unit other than the constituent unit (A-1) and the constituent unit (A-2). The constituent unit (A-3) is preferably represented by the following formula (3).

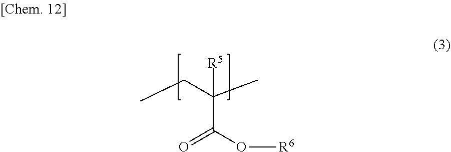

In formula (3), R⁵ represents a hydrogen atom, or an aliphatic saturated hydrocarbon group having 1 to 4 carbon atoms and containing a straight chain or a branched chain; and R⁶ represents an aliphatic saturated hydrocarbon group having 1 to 18 carbon atoms, preferably having 1 to 12 carbon atoms, or an aromatic hydrocarbon group having 6 to 19 carbon atoms, preferably having 6 to 12 carbon atoms, which optionally contains an ether bond and/or a sulfide bond and in which a hydrogen atom is optionally replaced by a hydroxyl group, a nitro group, a carboxy group, a salt of a carboxy group, a sulfo group, a salt of a sulfo group, an amino group, a nitroso group, a cyano group, a sulfino group, a fluorine atom, a bromine atom, an iodine atom, or an astatine atom.

The constituent unit (A-3) is preferably a constituent unit derived from the monomer (a-3). The monomer (a-3) is not particularly limited as long as it is a monomer which has a conjugated diene site, and is not contained in the monomer (a-1) or the monomer (a-2). Examples of the monomer (a-3) include (meth)acrylic acid esters, (meth)acrylic acid amides, vinyl compounds, styrenes, unsaturated dicarboxylic acid diesters, and unsaturated polybasic acid anhydrides.

The (meth)acrylic acid ester is preferably an ester compound from a carboxylic acid compound (a-3-1) and R⁶—OH (a-3-2).

The carboxylic acid compound (a-3-1) is preferably (meth)acrylic acid.

In R⁶—OH (a-3-2), R⁶ has the same meaning as the symbol in formula (3). Examples of R⁶ include a methyl group, an ethyl group, an n-butyl group, an i-butyl group, a sec-butyl group, a t-butyl group, an n-propyl group, an i-propyl group, a 2-ethylhexyl group, an n-dodecyl group, and a benzyl group.

Of these, a methyl group, an ethyl group, a butyl group, a propyl group and a 2-ethylhexyl group are preferable.

Examples of the (meth)acrylic acid ester include methyl (meth)acrylate, ethyl (meth)acrylate, n-propyl (meth)acrylate, isopropyl (meth)acrylate, n-butyl (meth)acrylate, sec-butyl (meth)acrylate, isobutyl (meth)acrylate, tert-butyl (meth)acrylate, pentyl (meth)acrylate, neopentyl (meth)acrylate, benzyl (meth)acrylate, isoamyl (meth)acrylate, hexyl (meth)acrylate, 2-ethylhexyl (meth)acrylate, lauryl (meth)acrylate, cyclopentyl (meth)acrylate, cyclohexyl (meth)acrylate, methylcyclohexyl (meth)acrylate, and ethylcyclohexyl (meth)acrylate. Of these, methyl (meth)acrylate and butyl (meth)acrylate are preferable.

Specific examples of the (meth)acrylic acid amide include (meth)acrylic acid amide, (meth)acrylic acid N,N-dimethylamide, (meth)acrylic acid N,N-diethylamide, (meth)acrylic acid N,N-dipropylamide, (meth)acrylic acid N,N-di-isopropylamide, (meth)acrylic acid anthracenylamide, N-isopropyl (meth)acrylamide, (meth)acrylmorpholine, and diacetone (meth)acrylamide.

Specific examples of the vinyl compound include norbornene (bicyclo[2.2.1]hept-2-ene), 5-methylbicyclo[2.2.1]hept-2-ene, 5-ethylbicyclo[2.2.1]hept-2-ene, tetracyclo[4.4.0.1^{2,5}.1^{7,10}]dodec-3-ene, 8-methyltetracyclo[4.4.0.1^{2,5}.1^{7,10}]dodec-3-ene, 8-ethyltetracyclo[4.4.0.1^{2,5}.1^{7,10}]dodec-3-ene, dicyclopentadiene, tricyclo[5.2.1.0^{2,6}]dec-8-ene, tricyclo[5.2.1.0^{2,6}]dec-3-ene, tricyclo[4.4.0.1^{2,3}]undec-3-ene, tricyclo[6.2.1.0^{1,8}]undec-9-ene, tricyclo[6.2.1.0^{1,8}]undec-4-ene, tetracyclo[4.4.0.1^{2,5}.1^{7,10}0.^{1,6}]dodec-3-ene, 8-methyltetracyclo[4.4.0.1^{2,5}.1^{7,10}0.^{1,6}]dodec-3-ene, 8-ethylidenetetracyclo[4.4.0.1^{2,5}.1.^{7,12}]dodec-3-ene, 8-ethylidenetetracyclo[4.4.0.1^{2,5}.1^{7,10}0.^{1,6}]dodec-3-ene, pentacyclo[6.5.1.1^{3,6}.0^{2,7}.0^{9,13}]pentadec-4-ene, pentacyclo[7.4.0.1^{2,5}.1^{9,12}.0^{8,13}]pentadec-3-ene, 5-norbornene-2,3-dicarboxylic anhydride, (meth)acrylic acid anilide, (meth)acryloyl nitrile, acrolein, vinyl chloride, vinylidene chloride, vinyl fluoride, vinylidene fluoride, vinyl pyridine, vinyl acetate, vinyl toluene, and norbornene.

Specific examples of the styrene include styrene, α-, o-, m-, p-alkyl, nitro, cyano and amide derivatives of styrene.

Specific examples of the unsaturated dicarboxylic acid diester include diethyl citraconate, diethyl maleate, diethyl fumarate, and diethyl itaconate.

Specific examples of the unsaturated polybasic acid anhydride include maleic anhydride, itaconic anhydride, and citraconic anhydride.

The constituent unit (A-3) may be of one type or a combination of two or more types.

The content ratio of the constituent unit (A-3) when the total content of all constituent units of the polymer (A) is defined as 100 mol % is preferably 1.0 mol % or more, more preferably 5.0 mol % or more, further preferably 10.0 mol % or more, and particularly preferably 60.0 mol % or more, and preferably 99.5 mol % or less, more preferably 99.0 mol % or less, further preferably 97.0 mol % or less, and particularly preferably 95.0 mol % or less.

### [Method for Producing Polymer Emulsion (B)]

A polymer emulsion (B) according to an embodiment of the present invention can be produced by a known method.

Preferably, emulsion polymerization is performed by, for example, emulsifying and dispersing the monomer (a-1) and water preferably with a surfactant to prepare a monomer emulsion in advance, subsequently charging a reaction container with water and preferably a surfactant, heating the mixture, then adding the prepared monomer emulsion dropwise, and preferably adding a radical polymerization initiator as appropriate. However, the method is not limited to this production method. The reaction temperature and the reaction time can be appropriately set according to the type and the amount of a monomer used.

The monomer (a-2) and/or the monomer (a-3) may be used in production of the polymer emulsion (B).

The proportions of the monomer (a-1) that are used in production of the polymer emulsion (B), and the polymer (a-2) and the polymer (a-3) that are preferably used in the production are such that the proportion of the monomer (a-1) when the proportion of all the monomers is defined as 100 mol % is 0.5 mol % or more, preferably 1.0 mol % or more, and more preferably 2.0 mol % or more, and 40.0 mol % or less, preferably 35.0 mol % or less, and more preferably 30.0 mol % or more.

The proportion of the monomer (a-2) when the proportion of all the monomers is defined as 100 mol % is preferably 0.5 mol % or more, more preferably 1.0 mol % or more, and further preferably 1.5 mol % or more, and preferably 20.0 mol % or less, more preferably 15.0 mol % or less, and further preferably 10.0 mol % or less.

The proportion of the monomer (a-3) when the proportion of all the monomers is defined as 100 mol % is preferably 1.0 mol % or more, more preferably 5.0 mol % or more, further preferably 10.0 mol % or more, and particularly preferably 60.0 mol % or more, and preferably 99.5 mol % or less, more preferably 99.0 mol % or less, further preferably 97.0 mol % or less, and particularly preferably 95.0 mol % or less.

The amount of each of the monomers blended is substantially identical to the content of each of the constituent units when the total content of all constituent units of the polymer (A) is defined as 100 mol %.

The solvent of the polymer emulsion (B) of the present invention is water. The solvent may contain a solvent compatible with water, and the content thereof is preferably 2 mass % or less, more preferably 1 mass % or less, further preferably 0.5 mass % or less with respect to the total amount of the solvent. Examples of the solvent compatible with water include alcohols such as methanol, ethanol and isopropanol; ethers such as ethylene glycol monomethyl ether and propylene glycol monoethyl ether; ketones such as acetone and methyl ethyl ketone.

The polymer emulsion (B) is preferably polymerized in the presence of a surfactant (C), a chain transfer agent (D) and a polymerization initiator (E).

### [Surfactant (C)]

The polymer emulsion (B) is preferably produced in the presence of the surfactant (C). The surfactant is not particularly limited. It is possible to use one or more of a nonionic emulsifier, an anionic emulsifier and a reactive surfactant that are commonly used. The surfactant (C) is preferably an anionic emulsifier or a reactive surfactant, and more preferably a reactive surfactant from the viewpoint of suppressing bleed-out of the surfactant to the surface after drying of the polymer emulsion.

Examples of the nonionic emulsifier include polyoxyethylene alkyl ether, polyoxyethylene alcohol ether, polyoxyethylene alkyl phenyl ether, polyoxyethylene polycyclic phenyl ether, polyoxyalkylene alkyl ether, a sorbitan fatty acid ester, a polyoxyethylene fatty acid ester, and a polyoxyethylene sorbitan fatty acid ester.

Examples of the anionic emulsifier include an alkylbenzene sulfonic acid salt, an alkyl sulfuric acid ester salt, a polyoxyethylene alkyl ether sulfuric acid ester salt, a polyoxyalkylene alkyl ether phosphoric acid ester or a salt thereof, a polyoxyalkylene alkyl phenyl ether phosphoric acid ester or a salt thereof, and a fatty acid salt, and examples of the salt include alkali metals such as sodium and potassium, ammonia, and amines.

Examples of the reactive surfactant include compounds having structures of formulae (4) to (6).

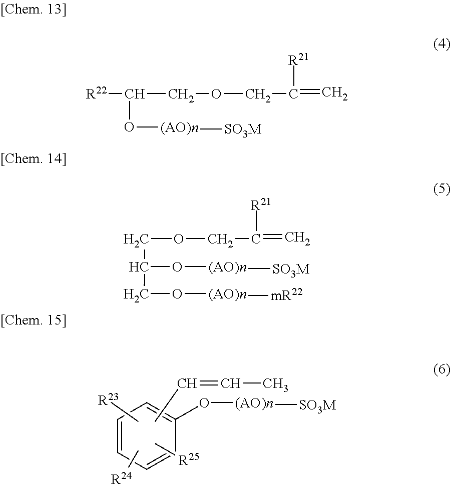

In formulae (4) to (6), each of R²¹, R²³, R²⁴ and R²⁵ is hydrogen or an alkyl group, R²² is, for example, an alkyl group or an alkyl phenyl group, A represents an alkylene group such as —CH₂—CH₂—, M represents an ammonium salt, or a salt of a metal such as potassium or sodium, n represents an integer of 2 to 20, and m represents an integer of 0 to 20.

Examples of the compound represented by formula (4) include AQUALON (registered trademark) KH-10 and KH-5 (manufactured by DKS Co. Ltd.). Examples of the compound represented by formula (5) include ADEKA REASOAP (registered trademark) SE-10N (manufactured by ADEKA CORPORATION). Examples of the compound represented by formula (6) include AQUALON (registered trademark) HS-10 (manufactured by DKS Co. Ltd.).

From the viewpoint that particle stability during polymerization can be secured and an increase in viscosity can be suppressed, the surfactant (C) is preferably contained at 0.1% or more and 20% or less, more preferably contained at 0.3% or more and 10% or less, and further preferably contained at 0.5% or more and 5% or less with respect to the solid content of the polymer (A).

### [Chain Transfer Agent (D)]

If necessary, a chain transfer agent can be used for adjusting the molecular weight of a polymer. The chain transfer agent is not particularly limited, and examples thereof include alkyl mercaptans such as n-hexyl mercaptan, n-octyl mercaptan, t-octyl mercaptan, n-dodecyl mercaptan, t-dodecyl mercaptan and n-stearyl mercaptan; 2,4-diphenyl-4-methyl-1-pentene, 2,4-diphenyl-4-methyl-2-pentene, and xanthogen compounds such as dimethyl xanthogen disulfide and diisopropyl xanthogen disulfide; thiuram-based compounds such as terpinolene, tetramethylthiuram disulfide, tetraethylthiuram disulfide and tetramethylthiuram monosulfide; phenolic compounds such as 2,6-di-t-butyl-4-methyl phenol and styrenated phenol; allyl compounds such as allyl alcohol, and halogenated hydrocarbon compounds such as dichloromethane, dibromomethane and carbon tetrabromide; vinyl ether such as α-benzyloxystyrene, α-benzyloxyacrylonitrile and α-benzyloxyacrylamide; and triphenylethane, pentaphenylethane, acrolein, methacrolein, isopropanol, thioglycolic acid, thiomalic acid, and 2-ethylhexyl thioglycolate. One of these compounds, or two or more thereof may be used. The amount of the chain transfer agent is not particularly limited, but is typically 0 to 5% with respect to the solid content of the polymer (A).

### [Polymerization Initiator (E)]

The polymer emulsion (B) is preferably produced in the presence of a polymerization initiator (E). The polymerization initiator and a reducing agent may be combined, and used as a redox polymerization initiator. As reducing agent, for example, potassium hydrogensulfite, sodium bisulfite, potassium sulfite or sodium sulfite can be used.

The polymerization initiator is not particularly limited, and examples thereof include inorganic polymerization initiators typified by persulfates such as potassium persulfate, sodium persulfate and ammonium persulfate; organic peroxide-based polymerization initiators such as 2,2-di(4,4-di-(t-butylperoxy)cyclohexyl)propane, 1-di-(t-hexylperoxy)cyclohexane, 1,1-di-(t-butylperoxy)cyclohexane, n-butyl 4,4-di-(t-butylperoxy)valerate, 2,2-di(t-butylperoxy)butane, t-butyl hydroperoxide, cumene hydroperoxide, benzoyl peroxide, diisopropylbenzene hydroperoxide, p-menthane hydroperoxide, 1,1,3,3-tetramethylbutyl hydroperoxide, t-butylcumyl peroxide, di-t-butyl peroxide, di-t-hexyl peroxide, di(2-t-butylperoxyisopropyl)benzene, dicumyl peroxide, diisobutyryl peroxide, di(3,5,5-trimethylhexanoyl)peroxide, dilauroyl peroxide, disuccinic acid peroxide, dibenzoyl peroxide, di(3-methylbenzoyl) peroxide, benzoyl(3-methylbenzoyl) peroxide, diisopropyl peroxydicarbonate, di-n-propyl peroxydicarbonate, di(4-t-butylcyclohexyl) peroxydicarbonate, di(2-ethylhexyl) peroxydicarbonate, di-sec-butyl peroxydicarbonate, cumyl peroxyneodecanate, 1,1,3,3-tetramethylbutyl peroxyneodecanate, t-hexyl peroxyneodecanate, t-butyl peroxyneodecanate, t-hexyl peroxypivalate, t-butyl peroxypivalate, 2,5-dimethyl-2,5-di(2-ethylhexanoylperoxy)hexane, 1,1,3,3-tetramethylbutyl peroxy-2-ethylhexanate, t-hexyl peroxy-2-ethylhexanate, t-butyl peroxy-2-ethylhexanate, t-butyl peroxylaurate, t-butyl peroxy-3,5,5-trimethylhexanate, t-hexyl peroxyisopropylmonocarbonate, t-butyl peroxyisopropylmonocarbonate, t-butyl peroxy-2-ethylhexylmonocarbonate, 2,5-dimethyl-2,5-di(benzoylperoxy)hexane, t-butyl peroxyacetate, t-hexyl peroxybenzoate, t-butyl peroxybenzoate and 2,5-dimethyl-2,5-di(t-butylperoxy)hexane; and azo-based initiators such a hydroperoxide, azobisisobutyronitrile, dimethyl 2,2′-azobis(isobutyrate), 4,4′-azobis(4-cyanovaleric acid), 2-2′-azobis[2-(2-imidazolin-2-yl)propane, 2-2′-azobis(propane-2-carboamidine)2-2′azobis[N-(2-carboxyethyl)-2-methylpropanamide, 2,2′-azobis{2-[1-(2-hydroxyethyl)-2-imidazolin-2-yl]propane}, 2-2′-azobis (1-imino-1-pyrrolidino-2-methylpropane) and 2,2′-azobis{2-methyl-N-[1,1-bis(hydroxymethyl)-2-hydroxyethyl]propaneamide}. These polymerization initiators may be used singly, or in combination or two or more thereof. The polymerization initiator (E) is preferably potassium persulfate, sodium persulfate, ammonium persulfate, t-butyl hydroperoxide, cumene hydroperoxide, benzoyl peroxide, hydroperoxide, azobisisobutyronitrile, or dimethyl 2,2′-azobis(isobutyrate), and potassium persulfate, sodium persulfate and ammonium persulfate are more preferable because they have good solubility in water.

The polymerization initiator (E) is preferably contained at 0.01% or more and 5.0% or less, more preferably contained at 0.03% or more and 4.0% or less, and further preferably contained at 0.05% or more and 3.0% or less with respect to the solid content of the polymer (A). When the content of the polymerization initiator (E) is 0.01% or more and 5.0% or less, the amount of residual monomers after reaction can be reduced, and influences of an initiator-derived structure on physical properties can be suppressed, which is preferable.

The polymer emulsion (B) may contain one or more of a defoaming agent, a filler, a leveling agent and a solvent.

The glass transition temperature of the solid content in the polymer emulsion (B) is preferably 0° C. or higher and 110° C. or lower, more preferably 25° C. or higher and 105° C. or lower, and further preferably 45° C. or higher and 100° C. or lower. A glass transition temperature of 110° C. or lower is preferable because crosslinking rapidly progresses during thermal curing at a low temperature, and a glass transition temperature of 0° C. or higher is preferable because stability of blocking groups is obtained.

### <Two-Component Thermosetting Resin Composition (G)>

An embodiment of the present invention is a two-component thermosetting resin composition (G) comprising the polymer emulsion (B), and an acrylic polyol polymer emulsion (F) described later, and containing a constituent unit (A-1) and (A-3) in a polymer (A). The polymer emulsion (B) and the acrylic polyol emulsion (F) are separately prepared, then mixed and used, or stored in separate containers until being used. The two-component thermosetting resin composition (G) can be preferably used as a coating material.

### [Acrylic Polyol Polymer Emulsion (F)]

The acrylic polyol polymer emulsion (F) is not limited, and a heretofore known acrylic polyol polymer emulsion can be used, but an emulsion containing an acrylic polyol polymer represented by the following formula (7) is preferable.

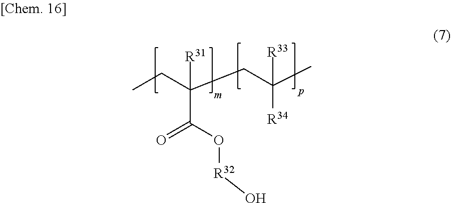

In formula (7), R³¹ and R³³ each independently represent a hydrogen atom, or an aliphatic saturated hydrocarbon group having 1 to 6 carbon atoms, preferably having 1 to 4 carbon atoms, and containing a straight chain or a branched chain, and R³² represents a divalent aliphatic saturated hydrocarbon group having 1 to 20 carbon atoms, preferably having 1 to 8 carbon atoms, and optionally having an ester bond and/or a carbonyl group, or an aromatic hydrocarbon group having 6 to 20 carbon atoms, preferably having 6 to 10 carbon atoms. R³⁴ represents a hydrocarbon having 1 to 20 carbon atoms, preferably having 1 to 8 carbon atoms. m represents an integer of 1 or more, and p represents 0, or an integer of 1 or more.

The acrylic polyol polymer emulsion (F) can be obtained by, for example, copolymerizing a mixture containing a hydroxyl group-containing polymerizable unsaturated monomer and another polymerizable unsaturated monomer capable of being copolymerized with the hydroxyl group-containing polymerizable unsaturated monomer, by a known method, for example, a method such as a bulk polymerization method, a method of solution polymerization in an organic solvent, or a method of emulsion polymerization in water.

Examples of the hydroxyl group-containing polymerizable unsaturated monomer include a monoester of a polyhydric alcohol and (meth)acrylic acid, such as 2-hydroxyethyl (meth)acrylate, 2-hydroxypropyl (meth)acrylate, 3-hydroxypropyl (meth)acrylate, 3-hydroxyphenyl (meth)acrylate, 4-hydroxybutyl (meth)acrylate, 6-hydroxyhexyl (meth)acrylate, mono-2-((meth)acryloyloxy)ethylsuccinic acid, polyethylene glycol mono(meth)acrylate or polypropylene glycol (meth)acrylate, and a compound obtained by ring-opening polymerization of e-caprolactone with the monoester of the polyhydric alcohol and (meth)acrylic acid, and these can be used singly, or in combination of two or more thereof. Of these, 2-hydroxyethyl (meth)acrylate can be preferably used.

Examples of the other polymerizable unsaturated monomer capable of being copolymerized include alkyl esters of (meth)acrylic acid such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl acrylate, cyclohexyl (meth)acrylate, n-octyl (meth)acrylate, lauryl (meth)acrylate, isobornyl (meth)acrylate and stearyl (meth)acrylate; carboxyl group-containing polymerizable unsaturated monomers such as (meth)acrylic acid, maleic acid and maleic anhydride; aminoalkyl (meth)acrylates such as N,N-dimethylaminoethyl (meth)acrylate, N,N-diethylaminoethyl (meth)acrylate and N,N-dimethylaminopropyl (meth)acrylate; (meth)acrylamide or derivatives thereof such as acrylamide, methacrylamide, N,N-dimethylaminoethyl (meth)acrylamide, N,N-diethylaminoethyl (meth)acrylamide, N,N-dimethylaminopropyl (meth)acrylamide, N-methylol acrylamide, N-methylol acrylamide methyl ether and N-methylol acrylamide butyl ether; quaternary ammonium base-containing monomers such as 2-(methacryloyloxy)ethyltrimethylammonium chloride and 2-(methacryloyloxy)ethyltrimethylammonium bromide; sulfoalkyl (meth)acrylates such as (meth)acrylamide-alkanesulfonic acids such as 2-acrylamide-2-methylpropanesulfonic acid, and 2-sulfoethyl (meth)acrylate; acrylonitrile, methacrylonitrile, vinyl acetate, styrene, vinyl toluene and a-methylstyrene; polyvinyl compounds such as allyl methacrylate; and hydrolyzable silyl group-containing polymerizable unsaturated monomers such as γ-(meth)acryloyloxypropyl trimethoxysilane, γ-(meth)acryloyloxypropyl triethoxysilane and γ-(meth)acryloyloxypropylmethyl dimethoxysilane. These can be used singly, or in combination of two or more thereof. Of these, (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl acrylate, and cyclohexyl (meth)acrylate can be preferably used.

The ratio between the number of moles of (A-1) in the polymer emulsion (B) and the number of moles of hydroxyl groups in the acrylic polyol polymer emulsion (F) (number of moles of (A-1) in the polymer emulsion (B):number of moles of hydroxyl groups in the acrylic polyol polymer emulsion (F)) is preferably 2:1 to 1:4, more preferably 1.5:1 to 1:3, and further preferably 1:1 to 1:2.5.

The two-component thermosetting resin composition (G) contains a pigment, a dye, an anti-aging agent, a thickener and a filler if necessary. The two-component thermosetting resin composition (G) can be preferably used as a coating material.

### <Resin Cured Film (H)>

An embodiment of the present invention is a resin cured film (H) obtained by curing the two-component thermosetting resin composition (G). The resin cured film (H) can be obtained by mixing the prepared polymer emulsion (B) and the acrylic polyol polymer emulsion (F), and thermally curing the mixture by a known method. The temperature during the thermal curing is preferably 80° C. or higher, and more preferably 90° C. or higher, and preferably 120° C. or lower, and more preferably 110° C. or lower. The resin cured film (H) may be formed by crosslinking of the constituent unit (A-1) in the polymer emulsion (B) and the acrylic polyol polymer in the acrylic polyol polymer emulsion (F).

The resin cured film (H) can be preferably used as a coating film (I), a coating agent (J) or an adhesive (K).

### <Method for Storing Polymer Emulsion (B)>

An embodiment of the present invention is a method for storing a polymer emulsion (B), comprising storing the polymer emulsion (B) at a temperature of 0° C. to 25° C., preferably 2° C. to 10° C. When the temperature is in the above-described range, decomposition of the constituent unit (A-1) by reaction of a blocking group (—R¹¹) derived from a blocking agent (a-1-2) in the constituent unit (A-1) and water in the polymer emulsion (B) can be suppressed. Storage conditions other than the temperature, and the storage period can be appropriately set.

### EXAMPLES

Hereinafter, the present invention will be further specifically described with reference to Examples and Comparative Examples, but it should be understood that the present invention is not limited to Examples below.

### [Evaluation of Solid Content Concentration]

For the solid content concentration, the polymer emulsion (B) obtained in each of Examples 1 to 8 was weighed and put on an aluminum dish, and then dried by performing heat treatment (at 141° C. for 30 minutes), so that only a solid content remained. From the mass before the drying and the mass after the drying, the solid content concentration was calculated in accordance with the following expression. A similar procedure was carried out for Comparative Examples 1 and 2.

$$( ( mass before drying ) - ( mass after drying ) ) \div ( mass before drying ) \times 100 ( \% )$$

### [Measurement of Molecular Weight]

To about 0.1 g of the polymer emulsion (B) obtained in each of Examples 1 to 8, 1.5 ml of tetrahydrofuran was added, the mixture was then manually shaken to dissolve the polymer emulsion (B), and the number average molecular weight (Mn) and the weight average molecular weight (Mw) were measured by a gel permeation chromatography (GPC) method, and determined in terms of polystyrene. A similar procedure was carried out for Comparative Examples 1 and 2.

### [Measurement of Glass Transition Temperature]

For the glass transition temperature (Tg), about 1 g of the polymer emulsion (B) obtained in each of Examples 1 to 8 was put in an aluminum cup, dried at 25° C. for 24 hours, and then stored in a desiccator for 12 hours to acquire a dried resin. The acquired dried resin was weighed to about 7 mg, and put in a non-sealing-type aluminum pan, and the glass transition temperature was calculated from a change in heat flow when the resin was heated at a temperature increase rate of 10° C./min from −20° C. to 120° C., then cooled to −20° C., and heated to 120° C. again by differential scanning calorimetry (EXSTAR 6000 manufactured by Hitachi High-Tech Science Corporation). A similar procedure was carried out for Comparative Examples 1 and 2.

[Evaluation of tensile strength Tb, elongation at break Eb, modulus at 100% elongation M100, modulus at 300% elongation M300 and modulus at 500% elongation M500 for film]

The resin dried film or resin cured film obtained in each of Examples 1 to 8 or Comparative Examples 1 and 2 was peeled from a glass substrate, and then cut into a No. 8 dumbbell type. The resin dried film or resin cured film cut out was subjected to a tensile test using a tension and compression tester (AUTOGRAPH AGS-500 NX manufacture by Shimadzu Corporation; tension rate: 50 mm/min, temperature: 23° C. to Tg+15° C.). The tensile test was conducted by a method conforming to JIS-K 7127-1999. By the present test, a modulus at 100% elongation (M100), a modulus at 300% elongation (M300), a modulus at 500% elongation (M500), a tensile strength (Tb) and an elongation at break (Eb) were measured at room temperature.

### [Evaluation of Storage Stability]

The polymer emulsion (B) obtained in each of Examples 1 to 8 was stored at 23° C. for a predetermined time, followed by evaluation of stability by quantification of R³OH and R⁴OH generated in the polymer emulsion (B) (R³ and R⁴ have the same meanings as the symbols in formula (1)). Upon decomposition due to the reaction with water, the blocking group in the polymer emulsion (B) releases R³OH and R⁴OH identical in amount of substance to the blocking group, and carbon dioxide, and accordingly the decomposition ratio of the blocking group can be calculated from the content of R³OH and R⁴OH in the polymer, and used as an index of storage stability. The quantification of R³OH and R⁴OH in the polymer was performed by adding about 1 g of the polymer emulsion (B) to about 20 g of cyclohexane, sufficiently mixing the mixture, and then subjecting the supernatant to gas chromatography with Agilent 6850 (manufactured by Agilent Technologies, Inc). A similar procedure was carried out for Comparative Examples 1 and 2. A decomposition ratio of 80% or less, preferably 50% or less, indicates excellent storage stability.

### [Reagents Used]

Abbreviations of compounds used in Examples and Comparative Examples are shown below. [Constituent Unit (A-1)]

AOI-DEM: Malonic acid-2-[[[[2-[1-oxo-2-propenyl]oxy]ethyl]amino]carbonyl]-1,3-diethyl ester (manufactured by Showa Denko K.K.) MOI-DEM: Malonic acid-2-[[[[2[2-methyl-1-oxo-2-propenyl]oxy]ethyl]amino]carbonyl]-1,3-diethyl ester (manufactured by Showa Denko K.K.)

### [Constituent Unit (A-2)]

Aa: Acrylic acid (manufactured by Kanto Chemical Co., Inc.)

### [Constituent Unit (A-3)]

BuA: Butyl acrylate (manufactured by Kanto Chemical Co., Inc.)

MMA: Methyl methacrylate (manufactured by Kanto Chemical Co., Inc.)

### [Other Components]

DMPCEA: 2-[(3,5-Dimethylpyrazolyl)carbonylamino]ethyl acrylate (manufactured by Showa Denko K.K.)

NaSS: Sodium styrenesulfonate (manufactured by Tokyo Chemical Industry Co., Ltd.)

### [Surfactant]

KH-10: AQUALON (registered trademark) KH-10 (manufactured by DKS Co. Ltd.)

### [Chain Transfer Agent]

OTG: 2-Ethylhexyl thioglycolate (manufactured by FUJIFILM Wako Pure Chemical Corporation)

### [Polymerization Initiator]

KPS: Potassium persulfate (manufactured by Kanto Chemical Co., Inc.)

### [Reducing Agent]

SBS: Sodium bisulfite (manufactured by Kanto Chemical Co., Inc.)

### Preparation Example 1

An acrylic polyol polymer emulsion (F) was prepared as follow.

A 500 mL four-neck flask equipped with a stirrer, a condenser and a thermometer was charged with 139 g of deionized water, and heated to an internal temperature of 80° C. in a water bath while the inside of the system was purged with nitrogen gas. Separately, a 300 mL glass beaker was charged with 3.0 g of acrylic acid (manufactured by Kanto Chemical Co., Inc.), 60 g of methyl methacrylate (manufactured by Kanto Chemical Co., Inc.), 90 g of n-butyl acrylate (manufactured by Kanto Chemical Co., Inc.), 7.0 g of n-butyl methacrylate (manufactured by Kanto Chemical Co., Inc.), 20 g of 2-hydroxyethyl methacrylate (manufactured by Kanto Chemical Co., Inc.), 20 g of styrene (manufactured by Kanto Chemical Co., Inc.), 1.6 g of 2-ethylhexyl thioglycolate (manufactured by FUJIFILM Wako Pure Chemical Corporation), 100 g of deionized water and 3.0 g of AQUALON (registered trademark) KH-10, and the mixture was vigorously stirred with a stirrer chip to prepare an emulsified liquid. To a container heated to 80° C. was added 30 g of the prepared emulsified liquid, and a separately prepared catalyst liquid A (0.60 g of potassium persulfate (manufactured by Kanto Chemical Co., Inc.), 11.4 g of deionized water) was then added at a time. Thirty minutes after the addition, the remaining emulsified liquid was added over 3 hours, and simultaneously, a separately prepared catalyst B (60 mg of potassium persulfate, 1.1 g of deionized water) was added over 3 hours. After completion of the addition of the catalyst B, the mixture was aged at 80° C. for 1.5 hours. After completion of the aging, the aged product was cooled to 30° C. or lower, and neutralized with aqueous ammonia (manufactured by Kanto Chemical Co., Inc.) to a pH of 7.5 to 8.0 to obtain an intended acrylic polyol polymer emulsion (F) No residual monomer was detected in the emulsion except for 1,200 ppm of n-butyl acrylate, and thus it was confirmed that the composition of the polymer was substantially identical to the composition of monomers added. The solid content concentration was 45.4%.

### Example 1

A two-component thermosetting resin composition (G) and a resin cured film (H) were prepared as follows.

A 500 mL four-neck flask equipped with a stirrer, a condenser and a thermometer was charged with 110 g of deionized water, 0.05 g of AQUALON (registered trademark) KH-10 (manufactured by DKS Co. Ltd.), and 0.47 g of sodium bisulfite (manufactured by Kanto Chemical Co., Inc.), and heated to an internal temperature of 50° C. in a water bath while the inside of the system was purged with nitrogen gas. Separately, a 300 mL glass beaker was charged with 2.8 g of acrylic acid, 43.2 g of n-butyl acrylate, 134 g of methyl methacrylate, 20 g of a malonic acid-2-[[[[2-[1-oxo-2-propenyl]oxy]ethyl]amino]carbonyl]-1,3-diethyl ester (AOI-DEM), 1.45 g of 2-ethylhexyl thioglycolate, 110 g of deionized water, and 10 g of AQUALON (registered trademark) KH-10, and the mixture was vigorously stirred with a stirrer chip to prepare an emulsified liquid. To a container heated to 50° C. was added 32 g of the prepared emulsified liquid, and a separately prepared catalyst liquid A (0.26 g of potassium persulfate, 4.9 g of deionized water) was then added at a time. 30 minutes after the addition, the remaining emulsified liquid was added over 4 hours, and simultaneously, a separately prepared catalyst B (0.26 g of potassium persulfate, 4.9 g of deionized water) was added over 4 hours. After completion of the addition of the catalyst B, the mixture was aged for 1.5 hours. After completion of the aging, the aged product was cooled to 30° C. or lower, and neutralized with aqueous ammonia to a pH of 7.5 to obtain an intended polymer emulsion (B). No residual monomer was detected in the emulsion except for 1,500 ppm of n-butyl acrylate, and thus it was confirmed that the composition of the polymer was substantially identical to the composition of monomers added. The solid content concentration was 48.5%.

The obtained polymer emulsion (B) (polymer EM in Table 2) and the acrylic polyol polymer emulsion (F) obtained in Preparation Example 1 (AP polymer EM in Table 2) were mixed for 30 minutes at a composition for compound preparation shown in Table 2, thereby obtaining a two-component thermosetting resin composition (G) (copolymer emulsion) of Example 1.

The obtained two-component thermosetting resin composition (G) was applied to 50±20 μm onto a glass substrate coated with a mold release agent, and was cured at 100° C. for 15 minutes to obtain a resin cured film (H) of Example 1. For evaluation of a compound dried film after 2 months, the two-component thermosetting resin composition was stored at 23° C. in dry air for 2 months, and applied to 50±20 μm onto a glass substrate coated with a mold release agent, and was cured at 100° C. for 15 minutes to obtain a resin cured film.

### Examples 2 to 8, Comparative Examples 1 and 2

Except that the compositions were set to those described in Tables 1 and 2, the same procedure as in Example 1 was carried out to obtain polymer emulsions (B), two-component thermosetting resin compositions (G) and resin cured films (H) of Examples 2 to 8, and polymer emulsions, two-component thermosetting resin compositions and resin cured films of Comparative Examples 1 and 2.

Tables 1 to 3 show the results of evaluation and measurement in Examples 1 to 8 and Comparative Examples 1 and 2. In Tables 2 and 3, * indicates “not broken (<0.1)”, ** indicates “not broken (>0.9)”, *** indicates “not broken (>0.8)”, “more than 800” indicates an upper limit value in measurement, N/A indicates “measurement impossible”, and n/a indicates “not measured”.

TABLE 1

| | | | | Exam- | Exam- | Exam- | Exam- | Exam- | Exam- |
|---|---|---|---|---|---|---|---|---|---|
| | | | | ple 1 | ple 2 | ple 3 | ple 4 | ple 5 | ple 6 |
| Monomer | A-1 | AOI-DEM | g | 10 | 10 | 30 | 40 | | 10 |
| | | | mol % | 3.7 | 3.6 | 12.8 | 18.4 | | 4.0 |
| | | MOI-DEM | g | | | | | 10 | |
| | | | mol % | | | | | 3.5 | |
| | A-2 | Aa | g | 1.4 | 1.4 | 1.4 | 1.4 | 1.4 | 1.4 |
| | | | mol % | 2.2 | 2.1 | 2.5 | 2.7 | 2.1 | 2.3 |
| | A-3 | BuA | g | 21.6 | 11.7 | 11.7 | 6.7 | 11.6 | 49.2 |
| | | | mol % | 18.9 | 10.0 | 11.7 | 7.2 | 9.9 | 46.2 |
| | | MMA | g | 67.0 | 76.9 | 56.9 | 51.9 | 77.0 | 39.5 |
| | | | mol % | 75.2 | 84.2 | 73.0 | 71.7 | 84.5 | 47.5 |
| | Others | DMPCEA | g | | | | | | |
| | | | mol % | | | | | | |
| | | NaSS | g | | | | | | |
| | | | mol % | | | | | | |

| Monomer subtotal | | | 100.0 | 100.0 | 100.0 | 100.0 | 100.0 | 100.0 |
|---|---|---|---|---|---|---|---|---|
| Proportion of functional groups | | wt % | 10 | 10 | 30 | 40 | 10 | 10 |
| Chain transfer agent | OTG | g | 0.72 | 0.74 | 0.63 | 0.59 | 0.74 | 0.64 |
| (example of | | | | | | | | |
| adjusting molecular | | | | | | | | |
| weight) | | | | | | | | |
| Surfactant | KH-10 | g | 10 | 10 | 10 | 10 | 10 | 10 |
| Water | Deionized | g | 103 | 103 | 103 | 103 | 103 | 103 |
| | water | | | | | | | |
| Polymerization | KPS | g | 0.47 | 0.47 | 0.47 | 0.47 | 0.47 | 0.47 |
| initiator | | | | | | | | |
| Reducing agent | SBS | g | 0.24 | 0.24 | 0.24 | 0.24 | 0.24 | 0.24 |

| Molecular weight | Mn | 26022 | 26163 | 32006 | 27766 | 25086 | 29158 |
|---|---|---|---|---|---|---|---|
| | Mw | 48837 | 49009 | 60535 | 52846 | 47144 | 56674 |
| | Mw/Mn | 1.9 | 1.9 | 1.9 | 1.9 | 1.9 | 1.9 |

| | | | | | | Comparative | Comparative |
|---|---|---|---|---|---|---|---|
| | | | | Example 7 | Example 8 | Example 1 | Example 2 |
| Monomer | A-1 | AOI-DEM | g | 10 | 10 | | |
| | | | mol % | 3.8 | 3.8 | | |
| | | MOI-DEM | g | | | | |
| | | | mol % | | | | |
| | A-2 | Aa | g | 1.4 | 1.4 | 1.4 | |
| | | | mol % | 2.2 | 2.2 | 2.1 | |
| | A-3 | BuA | g | 32.8 | 27.0 | 26.6 | 21.6 |
| | | | mol % | 29.6 | 24.0 | 21.9 | 18.9 |
| | | MMA | g | 55.8 | 61.6 | 72.0 | 67.9 |
| | | | mol % | 64.3 | 70.0 | 76.0 | 76.1 |
| | Others | DMPCEA | g | | | | 10 |
| | | | mol % | | | | 4.7 |
| | | NaSS | g | | | | 0.5 |
| | | | mol % | | | | 0.3 |

| Monomer subtotal | | | 100.0 | 100.0 | 100.0 | 100.0 |
|---|---|---|---|---|---|---|
| Proportion of functional groups | | wt % | 10 | 10 | 0 | 10 |
| Chain transfer agent | OTG | g | 0.70 | 0.71 | 0.77 | 0.72 |
| (example of | | | | | | |
| adjusting molecular | | | | | | |
| weight) | | | | | | |
| Surfactant | KH-10 | g | 10 | 10 | 10 | 2.6 |
| Water | Deionized | g | 103 | 103 | 103 | 103 |
| | water | | | | | |
| Polymerization | KPS | g | 0.47 | 0.47 | 0.47 | 0.46 |
| initiator | | | | | | |
| Reducing agent | SBS | g | 0.24 | 0.24 | 0.24 | 0.42 |

| Molecular weight | Mn | 22916 | 26931 | 22622 | 26046 |
|---|---|---|---|---|---|
| | Mw | 48927 | 48568 | 43317 | 52048 |
| | Mw/Mn | 2.1 | 1.8 | 1.9 | 2.0 |

TABLE 2

| | | | | Exam- | Exam- | Exam- | Exam- | Exam- | Exam- |
|---|---|---|---|---|---|---|---|---|---|
| | | | | ple 1 | ple 2 | ple 3 | ple 4 | ple 5 | ple 6 |
| Solid content concentration | | | % | 48.5 | 48.5 | 45.5 | 45.1 | 48.5 | 48.2 |
| Tg | | | ° C. | 45 | 65 | 45 | 45 | 65 | 0 |
| Evaluation of storage | | Storage | At completion | 9 | 10 | 5 | 9 | 6 | 18 |
| stability | | period | of | | | | | | |
| (%) | | (23° C.) | polymerization | | | | | | |
| | | | 1 month | 12 | 17 | 25 | 18 | 17 | 50 |
| | | | 2 months | 22 | 24 | 41 | 24 | 31 | 79 |
| Compound | | Polymer EM | g | 5.0 | 5.0 | 2.5 | 2.5 | 5.0 | 6.9 |
| preparation | | AP polymer | g | 5.3 | 5.3 | 7.4 | 9.8 | 5.0 | 7.2 |
| | | EM | | | | | | | |
| Evaluation of | Before | Evaluation | Tb(MPa) | 8.2 | 8.5 | 4.3 | 4.2 | 10.5 | *** |
| compound | curing | temperature | Eb(%) | 174 | 179 | 370 | 381 | 16 | More |
| dried film | (dried | (23° C.) | | | | | | | than 800 |
| (immediately | at | | M100 | 7.1 | 7.4 | 3.7 | 3.3 | n/a | 0.6 |
| after | 40° C.) | | M300 | n/a | n/a | 4.2 | 4.1 | n/a | 0.7 |
| synthesis of | | | M500 | n/a | n/a | n/a | n/a | n/a | 0.8 |
| copolymer | After | Evaluation | Tb(MPa) | 18.8 | 19.9 | 11.7 | 8.7 | 21.8 | 9.2 |
| EM) | curing | temperature | Eb(%) | 113 | 91 | 187 | 230 | 54 | 198 |
| | (100° | (23° C.) | M100 | 17.7 | n/a | 8.1 | 5.9 | n/a | 2.0 |
| | C. × 15 | | M300 | n/a | n/a | n/a | n/a | n/a | n/a |
| | min) | | M500 | n/a | n/a | n/a | n/a | n/a | n/a |
| Evaluation of | Before | Evaluation | Tb(MPa) | 9.0 | 8.8 | 4.4 | 4.5 | 11.8 | *** |
| compound | curing | temperature | Eb(%) | 139 | 175 | 380 | 382 | 32 | More |
| dried film | (dried | (23° C.) | | | | | | | than 800 |
| (after 2 | at | | M100 | 8.2 | 7.5 | 3.8 | 3.2 | n/a | 0.6 |
| months at | 40° C.) | | M300 | n/a | n/a | 4.2 | 4.2 | n/a | 0.7 |
| 23° C.) | | | M500 | n/a | n/a | n/a | n/a | n/a | 0.7 |
| | After | Evaluation | Tb(MPa) | 18.2 | 20.0 | 11.2 | 8.5 | 19.5 | ** |
| | curing | temperature | Eb(%) | 100 | 87 | 182 | 225 | 59 | More |
| | (100° | (23° C.) | | | | | | | than 800 |
| | C. × 15 | | M100 | 18.2 | n/a | 8.0 | 5.8 | n/a | 0.7 |
| | min) | | M300 | n/a | n/a | n/a | n/a | n/a | 0.8 |
| | | | M500 | n/a | n/a | n/a | n/a | n/a | 0.8 |

| | | | | | | Comparative | Comparative |
|---|---|---|---|---|---|---|---|
| | | | | Example 7 | Example 8 | Example 1 | Example 2 |
| Solid content concentration | | | % | 48.5 | 48.5 | 49.6 | 49.4 |
| Tg | | | ° C. | 25 | 35 | 45 | 45 |
| Evaluation of storage | | Storage | At completion | 20 | 15 | n/a | N/A |
| stability | | period | of | | | | |
| (%) | | (23° C.) | polymerization | | | | |
| | | | 1 month | 37 | 28 | n/a | N/A |
| | | | 2 months | 54 | 39 | n/a | N/A |
| Compound | | Polymer EM | g | 5.0 | 5.0 | 5.0 | 3.0 |
| preparation | | AP polymer | g | 5.3 | 5.3 | 5.3 | 4.1 |
| | | EM | | | | | |
| Evaluation of | Before | Evaluation | Tb(MPa) | 1.5 | 10.4 | 6.5 | 6.7 |
| compound | curing | temperature | Eb(%) | 563 | 176 | 188 | 199 |
| dried film | (dried | (23° C.) | M100 | 3.1 | 9.8 | 5.6 | 8.0 |
| (immediately | at | | M300 | 2.3 | n/a | n/a | n/a |
| after | 40° C.) | | M500 | 1.6 | n/a | n/a | n/a |
| synthesis of | After | Evaluation | Tb(MPa) | 14.6 | 20.0 | 20.0 | 17.2 |
| copolymer | curing | temperature | Eb(%) | 167 | 129 | 54 | 120 |
| EM) | (100° | (23° C.) | M100 | 10.0 | 19.4 | n/a | 16.6 |
| | C. × 15 | | M300 | n/a | n/a | n/a | n/a |
| | min) | | M500 | n/a | n/a | n/a | n/a |
| Evaluation of | Before | Evaluation | Tb(MPa) | 2.0 | 9.8 | 6.6 | 6.8 |
| compound | curing | temperature | Eb(%) | 401 | 159 | 181 | 203 |
| dried film | (dried | (23° C.) | M100 | 3.2 | 9.4 | 5.8 | 7.9 |
| (after 2 | at | | M300 | 2.5 | n/a | n/a | n/a |
| months at | 40° C.) | | M500 | n/a | n/a | n/a | n/a |
| 23° C.) | After | Evaluation | Tb(MPa) | 12.1 | 16.2 | 19.7 | 17.5 |
| | curing | temperature | Eb(%) | 238 | 132 | 52 | 115 |
| | (100° | (23° C.) | M100 | 6.2 | 12.1 | n/a | 16.9 |
| | C. × 15 | | M300 | n/a | n/a | n/a | n/a |
| | min) | | M500 | n/a | n/a | n/a | n/a |

TABLE 3

| | | | | Exam- | Exam- | Exam- | Exam- | Exam- | Exam- |
|---|---|---|---|---|---|---|---|---|---|
| | | | | ple 1 | ple 2 | ple 3 | ple 4 | ple 5 | ple 6 |
| Evaluation of | Before | Evaluation | Tb(MPa) | 0.1 | 0.1 | * | * | 0.1 | ** |
| compound | curing | temperature | Eb(%) | 383 | 310 | More | More | 133 | More |
| dried film | (dried | (Tg + 15° C.) | | | | than 800 | than 800 | | than 800 |
| (immediately | at | | M100 | 0.1 | 0.2 | 0.1 | 0.1 | 0.1 | 0.6 |
| after | 40° C.) | | M300 | 0.1 | 0.1 | 0.1 | 0.1 | n/a | 0.7 |
| synthesis of | | | M500 | n/a | n/a | 0.1 | 0.1 | n/a | 0.8 |
| copolymer | After | Evaluation | Tb(MPa) | 5.8 | 1.8 | 2.8 | 1.2 | 1.8 | 9.1 |
| EM) | curing | temperature | Eb(%) | 294 | 237 | 188 | 312 | 194 | 201 |
| | (100° | (Tg + 15° C.) | M100 | 0.9 | 0.8 | 0.9 | 0.4 | 1.1 | 2.0 |
| | C. × 15 | | M300 | n/a | n/a | n/a | 1.0 | n/a | n/a |
| | min) | | M500 | n/a | n/a | n/a | n/a | n/a | n/a |
| Evaluation of | Before | Evaluation | Tb(MPa) | 0.1 | 0.1 | * | * | 0.1 | ** |
| compound | curing | temperature | Eb(%) | 379 | 301 | More | More | 121 | More |
| dried film | (dried | (Tg + 15° C.) | | | | than 800 | than 800 | | than 800 |
| (after 2 | at | | M100 | 0.1 | 0.2 | 0.1 | 0.1 | 0.1 | 0.7 |
| months at | 40° C.) | | M300 | 0.1 | 0.1 | 0.1 | 0.1 | n/a | 0.7 |
| 23° C.) | | | M500 | n/a | n/a | 0.1 | 0.1 | n/a | 0.7 |
| | After | Evaluation | Tb(MPa) | 5.6 | 1.7 | 2.8 | 1.2 | 1.7 | ** |
| | curing | temperature | Eb(%) | 305 | 241 | 190 | 314 | 186 | More |
| | (100° | (Tg + 15° C.) | | | | | | | than 800 |
| | C. × 15 | | M100 | 1.0 | 0.8 | 0.9 | 0.4 | 1.1 | 0.8 |
| | min) | | M300 | 5.5 | n/a | n/a | 1.0 | n/a | 0.8 |
| | | | M500 | n/a | n/a | n/a | n/a | n/a | 0.9 |

| | | | | | | Comparative | Comparative |
|---|---|---|---|---|---|---|---|
| | | | | Example 7 | Example 8 | Example 1 | Example 2 |
| Evaluation of | Before | Evaluation | Tb(MPa) | * | * | * | 0.1 |
| compound | curing | temperature | Eb(%) | More | More | More | 367 |
| dried film | (dried | (Tg + 15° C.) | | than 800 | than 800 | than 800 | |
| (immediately | at | | M100 | 0.4 | 0.3 | 0.2 | 0.1 |
| after | 40° C.) | | M300 | 0.2 | 0.1 | 0.1 | 0.1 |
| synthesis of | | | M500 | 0.1 | 0.0 | 0.1 | n/a |
| copolymer | After | Evaluation | Tb(MPa) | 11.1 | 9.1 | * | * |
| EM) | curing | temperature | Eb(%) | 172 | 188 | More | More |
| | (100° | (Tg + 15° C.) | | | | than 800 | than 800 |
| | C. × 15 | | M100 | 4.1 | 1.9 | 0.2 | 0.3 |
| | min) | | M300 | n/a | n/a | 0.1 | 0.3 |
| | | | M500 | n/a | n/a | 0.1 | 0.2 |
| Evaluation of | Before | Evaluation | Tb(MPa) | * | * | * | 0.1 |
| compound | curing | temperature | Eb(%) | More | More | More | 355 |
| dried film | (dried | (Tg + 15° C.) | | than 800 | than 800 | than 800 | |
| (after 2 | at | | M100 | 0.3 | 0.3 | 0.2 | 0.1 |
| months at | 40° C.) | | M300 | 0.1 | 0.1 | 0.1 | 0.1 |
| 23° C.) | | | M500 | 0.1 | 0.1 | 0.1 | n/a |
| | After | Evaluation | Tb(MPa) | 8.8 | 6.6 | * | * |
| | curing | temperature | Eb(%) | 253 | 288 | More | More |
| | (100° | (Tg + 15° C.) | | | | than 800 | than 800 |
| | C. × 15 | | M100 | 2.5 | 1.2 | 0.2 | 0.3 |
| | min) | | M300 | n/a | n/a | 0.1 | 0.3 |
| | | | M500 | n/a | n/a | 0.1 | 0.2 |

For the copolymer emulsions of Examples (copolymer EM in Table 3), Tb, M100 and M300 that increase with progress of crosslinking were much larger after curing than before in evaluation at Tg+15° C. immediately after synthesis (ΔTb: 1,000% or more, ΔM100 or ΔM300: +250% or more). On the other hand, for the copolymer emulsions of Comparative Examples, the percentage change in M100 or M300 was small in the evaluation (ΔM100 or ΔM300: +200% or less) (Tb is very small although ΔTb cannot be obtained because breakage did not occur). The values of, for example, Tb and M100 after storage at 23° C. for 2 months are little different from those immediately after synthesis, and excellent storage stability is exhibited.

1: A polymer emulsion (B) comprising a polymer (A) containing a constituent unit (A-1) represented by the following formula (1), and water, wherein
a content ratio of the constituent unit (A-1) when a total content of all constituent units of the polymer (A) is defined as 100 mol % is 0.5 mol % or more and 40 mol % or less: 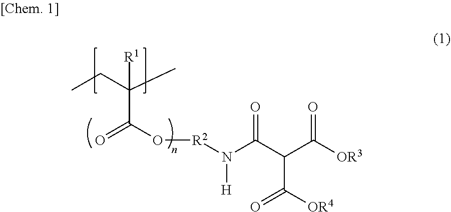
wherein R¹ represents a hydrogen atom or a methyl group, R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond, R³ and R⁴ each independently represent a hydrogen atom, an alkyl group having 1 to 10 carbon atoms, or a cycloalkyl group or arylalkyl group having 6 to 20 carbon atoms, and n is 1 or 2.

2: The polymer emulsion (B) according to claim 1, wherein the constituent unit (A-1) is represented by formula (1-1): 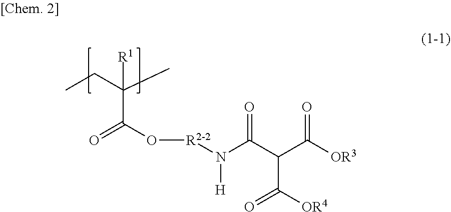
wherein R¹, R³ and R⁴ have the same meanings as the symbols in formula (1), and R²⁻² represents a divalent aliphatic saturated hydrocarbon group having 2 to 4 carbon atoms and optionally having an ether bond.

3: The polymer emulsion (B) according to claim 1, wherein the constituent unit (A-1) is represented by formula (1-2): 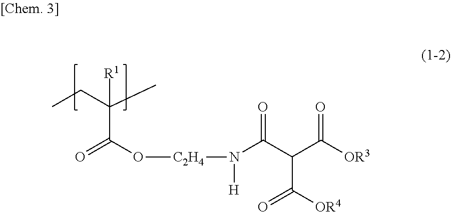
wherein R¹, R³ and R⁴ have the same meanings as the symbols in formula (1).

4: The polymer emulsion (B) according to claim 1, wherein each of R³ and R⁴ in the formula of the constituent unit (A-1) is an ethyl group.

5: The polymer emulsion (B) according to claim 1, wherein the polymer (A) contains a constituent unit (A-3) represented by the following formula (3) as a constituent unit of the polymer (A): 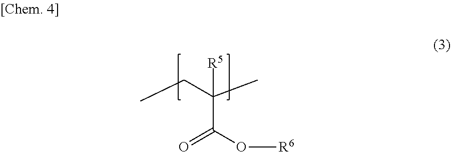
wherein R⁵ represents a hydrogen atom, or an aliphatic saturated hydrocarbon group having 1 to 4 carbon atoms and containing a straight chain or a branched chain; and R⁶ represents an aliphatic saturated hydrocarbon group having 1 to 18 carbon atoms or an aromatic hydrocarbon group having 6 to 19 carbon atoms, which optionally contains an ether bond and/or a sulfide bond and in which a hydrogen atom is optionally replaced by a hydroxyl group, a nitro group, a carboxy group, a salt of a carboxy group, a sulfo group, a salt of a sulfo group, an amino group, a nitroso group, a cyano group, a sulfino group, a chlorine atom, a fluorine atom, a bromine atom, an iodine atom, or an astatine atom.

6: The polymer emulsion (B) according to claim 1, wherein the polymer (A) further contains a constituent unit (A-2) represented by the following formula (2) as a constituent unit of the polymer: 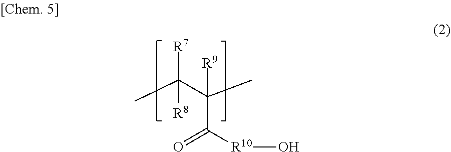
wherein R⁷, R⁸ and R⁹ each independently represent a hydrogen atom, or a hydrocarbon group containing a straight chain or a branched chain having 1 to 6 carbon atoms and optionally containing an ester bond and/or a carboxy group, and R¹⁰ represents a hydrocarbon group containing a straight chain or a branched chain having 0 to 18 carbon atoms and optionally having at least one selected from an ester bond, a carbonyl group and an ether bond.

7: The polymer emulsion (B) according to claim 1, wherein a glass transition temperature (Tg) of a solid content in the polymer emulsion (B) is 0° C. or higher and 110° C. or lower.

8: A two-component thermosetting resin composition (G) comprising the polymer emulsion (B) according to claim 5, and an acrylic polyol polymer emulsion (F).

9: The two-component thermosetting resin composition (G) according to claim 8, wherein a ratio between the number of moles of the constituent unit (A-1) in the polymer emulsion (B) and the number of moles of hydroxyl groups in the acrylic polyol polymer emulsion (F) is 2:1 to 1:4.

10: A resin cured film (H) obtained by curing the two-component thermosetting resin composition (G) according to claim 8.

11: A coating film (I) comprising the resin cured film (H) according to claim 10.

12: A method for storing a polymer emulsion (B), comprising storing the polymer emulsion (B) according to claim 1 at a temperature of 0° C. to 25° C.

13: A two-component thermosetting resin composition (G) comprising the polymer emulsion (B) according to claim 6, and an acrylic polyol polymer emulsion (F).

14: A method for storing a polymer emulsion (B), comprising storing the polymer emulsion (B) according to claim 2 at a temperature of 0° C. to 25° C.

15: A method for storing a polymer emulsion (B), comprising storing the polymer emulsion (B) according to claim 3 at a temperature of 0° C. to 25° C.

16: A method for storing a polymer emulsion (B), comprising storing the polymer emulsion (B) according to claim 4 at a temperature of 0° C. to 25° C.

17: A method for storing a polymer emulsion (B), comprising storing the polymer emulsion (B) according to claim 5 at a temperature of 0° C. to 25° C.

18: A method for storing a polymer emulsion (B), comprising storing the polymer emulsion (B) according to claim 6 at a temperature of 0° C. to 25° C.

19: A method for storing a polymer emulsion (B), comprising storing the polymer emulsion (B) according to claim 7 at a temperature of 0° C. to 25° C.
